(19) United States
(12) Patent Application Publication
(10) Pub. No.: US 2021/0225190 A1
(43) Pub. Date: Jul. 22, 2021

(54) INTERACTIVE EDUCATION SYSTEM

(71) Applicant: National Taiwan Normal University, Taipei City (TW)

(72) Inventors: Jon-Chao HONG, Taipei City (TW); Chia-Hung YEH, Taipei City (TW); Miao-Ling HSIEH, Taipei City (TW); Jung LIN, Taipei City (TW); Chien-Lin WU, Taipei City (TW); Wan-Shan LIN, Taipei City (TW)

(73) Assignee: National Taiwan Normal University, Taipei City (TW)

(21) Appl. No.: 17/010,244

(22) Filed: Sep. 2, 2020

(30) Foreign Application Priority Data
Jan. 21, 2020 (TW) 109102198

(51) Int. Cl. G09B 7/04; G09B 19/00; G10L 13/04; G10L 15/22; G10L 25/63; G06K 9/00; G10L 15/24

(52) U.S. Cl. CPC G09B 7/04; G09B 19/00; G10L 13/04; G10L 15/24; G10L 25/63; G06K 9/00335; G10L 15/22

(57) ABSTRACT

An interactive education system includes a storage, an output device, a processor, an input device and a recognition device. The processor controls the output device to produce voice based on a hint on a target answer stored in the storage. The recognition device generates a response through performing speech recognition on input data generated by the input device from voice of a user. The processor controls the output device to produce voice based on whether the response matches the target answer or any relevant characteristic. Depending on a count of consecutive occurrences of a failed event, the processor controls the output device to produce voice based on another hint or the target answer.

### CROSS-REFERENCE TO RELATED APPLICATION

This application claims priority of Taiwanese Invention Patent Application No. 109102198, filed on Jan. 21, 2020.

### FIELD

The disclosure relates to an education system, and more particularly to an interactive education system.

### BACKGROUND

In modern society, computers and televisions have been widely used as tools in education. However, most education programs on these platforms rely heavily on self-directed learning, and may be unappealing to younger children.

### SUMMARY

Therefore, an object of the disclosure is to provide an interactive education system that can alleviate at least one of the drawbacks of the prior art.

According to the disclosure, the interactive education system includes a storage device, an audio output device, a processor, an audio input device and a speech recognition device.

The storage device is configured to store in advance a plurality of reference answers, a plurality of hint sets each corresponding to a respective one of the reference answers and each including multiple hints on the respective one of the reference answers, and a plurality of characteristic sets each corresponding to a respective one of the reference answers and each including multiple characteristics of the corresponding reference answer.

The audio output device is configured to produce voice output to a user.

The processor is electrically connected to the storage device and the audio output device, and is configured to select one of the reference answers as a target answer, to select one of the hints in one of the hint sets that corresponds to the target answer, and to control the audio output device to produce the voice output based on the one of the hints thus selected.

The audio input device is configured to receive voice of the user, who makes a reply to the voice output, to generate input voice data.

The speech recognition device is electrically connected to the audio input device and the processor, and is configured to perform speech recognition on the input voice data to generate a submitted response.

The processor is further configured to determine, based on the submitted response, whether the submitted response matches either the target answer or any one of the characteristics in one of the characteristic sets that corresponds to the target answer. When it is determined that the submitted response matches the target answer, the processor is configured to control the audio output device to produce the voice output expressing that the user's reply is correct. When it is determined that the submitted response matches one of the characteristics in said one of the characteristic sets that corresponds to the target answer, the processor is configured to control the audio output device to produce the voice output that contains a positive expression. When it is determined that the submitted response matches neither the target answer nor any one of the characteristics in said one of the characteristic sets that corresponds to the target answer, the processor is configured to determine that a failed event has occurred, and control the audio output device to produce the voice output that contains a negative expression.

The processor is further configured to, when a count of consecutive occurrences of the failed event reaches a predetermined threshold, select another one of the hints in said one of the hint sets that corresponds to the target answer, and control the audio output device to produce the voice output based on the another one of the hints thus selected.

The processor is further configured to, when the counts of consecutive occurrences of the failed events for all the hints in said one of the hint sets that corresponds to the target answer have reached the predetermined threshold, control the audio output device to produce the voice output based on the target answer.

### BRIEF DESCRIPTION OF THE DRAWINGS

Other features and advantages of the disclosure will become apparent in the following detailed description of the embodiment with reference to the accompanying drawing, of which:

FIG. 1 is a block diagram illustrating an embodiment of an interactive education system according to the disclosure.

### DETAILED DESCRIPTION

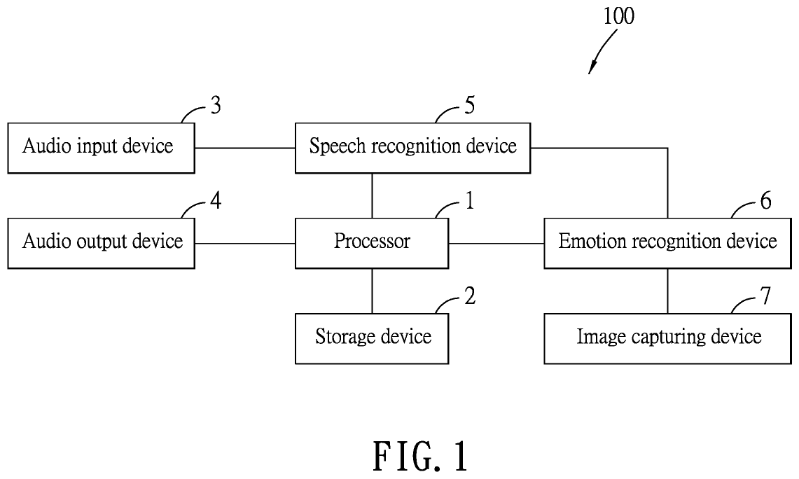

Referring to FIG. 1, an embodiment of an interactive education system 100 according to the disclosure is illustrated. The interactive education system 100 is adapted to be used by a user for expanding the user's vocabulary and improving the user's reasoning skills. In this embodiment, the user is a child, but is not limited thereto.

The interactive education system 100 includes a processor 1, a storage device 2, an audio input device 3, an audio output device 4, a speech recognition device 5, an emotion recognition device 6 and an image capturing device 7.

In this embodiment, the storage device 2 may be implemented by flash memory, a hard disk drive (HDD), a solid state disk (SSD), an electrically-erasable programmable read-only memory (EEPROM) or any other non-volatile memory devices, but is not limited thereto. The storage device 2 is configured to store in advance a plurality of reference answers, a plurality of hint sets and a plurality of characteristic sets. Each of the hint sets corresponds to a respective one of the reference answers, and includes multiple hints on the corresponding reference answer. The multiple hints are three in number in this embodiment, but maybe more than three in other embodiments. Each of the characteristic sets corresponds to a respective one of the reference answers, and includes multiple characteristics of the corresponding reference answer. In this embodiment, the characteristics in any individual one of the characteristic sets include one of a function, an appearance, a color, a growth factor, a growth environment, and any combination thereof of the corresponding reference answer. However, implementation of the characteristics is not limited to the disclosure herein and may vary in other embodiments. It is worth to note that the reference answers, the hint sets and the characteristic sets may be stored in the storage device 2 as audio files or text files.

The audio output device 4 is configured to produce voice output to the user. The audio output device 4 may be implemented to include a driving circuit receiving output voice data, and a speaker or a loudspeaker that is driven by the driving circuit to produce the voice output based on the output voice data. However, implementation of the audio output device 4 is not limited to the disclosure herein and may vary in other embodiments.

The processor 1 may be implemented by a central processing unit (CPU), a microprocessor, a micro control unit (MCU), or any circuit configurable/programmable in a software manner and/or hardware manner to implement functionalities discussed in this disclosure. The processor 1 is electrically connected to the storage device 2 and the audio output device 4. The processor 1 is configured to select one of the reference answers as a target answer, to select one of the hints in the hint set corresponding to the target answer, and to control the audio output device 4 to produce the voice output based on the one of the hints thus selected.

It should be noted that when the reference answers, the hint sets and the characteristic sets are stored as text files, the processor 1 performs text-to-speech conversion on the text files to obtain the voice output data so as to control the audio output device 4 to produce the voice output based thereon.

In an example used for explanation purposes, the reference answers include “agave”, “cactus”, “coffee”, “honey”, “glass”, “gypsum”, “toothbrush”, “kiwi”, “camel”, “hibiscus”, “mimosa” and “Mendeleev”. The hint set corresponding to the reference answer “cactus” includes three hints, namely “growing in desert”, “succulent plant” and “pointy leaf tips”. The hint set corresponding to the reference answer “coffee” includes three hints, namely “important cash crop”, “stimulating effect” and “roasted beans”. The hint set corresponding to the reference answer “honey” includes three hints, namely “monosaccharide”, “anaerobic bacteria” and “bees”. The hint set corresponding to the reference answer “glass” includes three hints, namely “transparent and brittle”, “amorphous” and “silicon dioxide being the primary constituent”. The hint set corresponding to the reference answer “gypsum” includes three hints, namely “reclamation of alkaline soil”, “models and molds making” and “calcium sulfate”. The hint set corresponding to the reference answer “toothbrush” includes three hints, namely “hygiene instrument”, “oral cleaning” and “tightly clustered bristles”. The hint set corresponding to the reference answer “kiwi” includes three hints, namely “cannot fly”, “male incubates eggs” and “national bird of New Zealand”. The hint set corresponding to the reference answer “camel” includes three hints, namely “storing water in stomach”, “nostrils can close” and “the ship of the desert”. The hint set corresponding to the reference answer “hibiscus” includes three hints, namely “deciduous shrub”, “daily bloom” and “national flower of the Republic of Korea”. The hint set corresponding to the reference answer “mimosa” includes three hints, namely “opposite leaf arrangement”, “folding leaves” and “turgor pressure”. The hint set corresponding to the reference answer “Mendeleev” includes three hints, namely “inventor of pyrocollodion”, “Russian scientist” and “formulating the periodic table of chemical elements”.

The audio input device 3 is configured to receive voice of the user, who makes a reply to the voice output, to generate input voice data. The audio input device 3 maybe implemented to include a microphone and an audio recorder, but implementation of the audio input device 3 is not limited to the disclosure herein and may vary in other embodiments.

The speech recognition device 5 is electrically connected to the audio input device 3 and the processor 1. The speech recognition device 5 is configured to perform speech recognition on the input voice data to generate a submitted response. The speech recognition device 5 may be implemented as a single chip, a computation module of a chip, or a circuit configurable/programmable in a software and/or hardware manner to implement functionalities discussed in this disclosure.

The processor 1 is further configured to determine, based on the submitted response, whether the submitted response matches either the target answer or any one of the characteristics in the characteristic set corresponding to the target answer. It should be noted that the determination as to whether the submitted response matches either the target answer or any one of the characteristics in the characteristic set corresponding to the target answer is made by a semantic-based approach instead of a character-based approach. In other words, the aforementioned determination is made based on a match between the meanings of the submitted response and the target answer (or the characteristic).

When it is determined that the submitted response matches one of the characteristics in the characteristic set corresponding to the target answer, the processor 1 controls the audio output device 4 to produce the voice output that contains a positive expression. After that, the processor 1 determines, based on another submitted response, whether said another submitted response matches either the target answer or any one of the characteristics in the characteristic set corresponding to the target answer.

When it is determined that the submitted response matches the target answer, the processor 1 controls the audio output device 4 to produce the voice output expressing that the user's reply is correct. After controlling the audio output device 4 to produce the voice output expressing that the user's reply is correct, the processor 1 selects another one of the reference answers as another target answer, selects one of the hints in the hint set corresponding to said another target answer, and controls the audio output device 4 to produce the voice output based on the one of the hints thus selected in the hint set corresponding to said another target answer.

When it is determined that the submitted response matches neither the target answer nor any one of the characteristics in the characteristic set corresponding to the target answer, the processor 1 determines that a failed event has occurred, and controls the audio output device 4 to produce the voice output that contains a negative expression. Subsequently, when a count of consecutive occurrences of the failed event reaches a predetermined threshold, the processor 1 is further configured to select another one of the hints in the hint set corresponding to the target answer, and to control the audio output device 4 to produce the voice output based on the another one of the hints thus selected. It should be noted that in this embodiment, a counter (not shown) is utilized to count the occurrences of the failed event, and an initial value of the counter is zero. The value kept by the counter is increased by one for each occurrence of the failed event, and the predetermined threshold is three. In addition, the counter is reset to zero when it is determined that the submitted response matches either the target answer or any one of the characteristics in the characteristic set corresponding to the target answer or when a new hint (i.e., another one of the hints in the hint set) on the target answer is provided to the user. However, implementation of counting the occurrences of the failed event is not limited to the disclosure herein and may vary in other embodiments. When the counts of consecutive occurrences of the failed events for all the hints in the hint set corresponding to the target answer have all reached the predetermined threshold, the processor 1 is further configured to control the audio output device 4 to produce the voice output based on the target answer.

In a scenario where the reference answer “cactus” is selected as the target answer, the processor 1 selects the hint “growing in desert” in the hint set that corresponds to the target answer “cactus”, and controls the audio output device 4 to produce the voice output based on the hint “growing in desert” thus selected. When the user's reply is “Animal?” and the submitted response generated by the speech recognition device 5 is “animal”, the processor 1 determines that the submitted response “animal” matches neither the target answer “cactus” nor any one of the characteristics in the characteristic set corresponding to the target answer “cactus”, and controls the audio output device 4 to produce the voice output that contains a negative expression such as “No”. At the same time, the processor 1 determines that the failed event has occurred, and hence increases the value kept by the counter by one. As a result, the count of consecutive occurrences of the failed event is one. Later on, when the user replies “Plant?” and the submitted response generated by the speech recognition device 5 is “plant”, the processor 1 determines that the submitted response “plant” semantically matches a characteristic in the characteristic set corresponding to the target answer “cactus”, so the processor 1 controls the audio output device 4 to produce the voice output that contains a positive expression such as “Yes”. Additionally, the processor 1 resets the counter to zero.

Further, when the user replies with a response “Agave?” and the submitted response generated by the speech recognition device 5 is “agave”, the processor determines that the submitted response “agave” matches neither the target answer “cactus” nor anyone of the characteristics in the characteristic set corresponding to the target answer “cactus”, and controls the audio output device 4 to produce the voice output that contains the negative expression “No”. At the same time, the processor 1 determines that the failed event has occurred, and hence increases the value of the counter by one. Consequently, the count of consecutive occurrences of the failed event is one. Next, when the user replies with a response “Aloe?” and the submitted response generated by the speech recognition device 5 is “aloe”, the processor 1 determines that the submitted response “aloe” matches neither the target answer “cactus” nor any one of the characteristics in the characteristic set corresponding to the target answer “cactus”, and hence controls the audio output device 4 to produce the voice output that contains the negative expression “No”. Similarly, the processor 1 determines that the failed event has occurred again, and increases the value of the counter by one, so currently, the count of consecutive occurrences of the failed event is two. Afterwards, when the user replies with a response “Stapelia variegata Linn?” and the submitted response generated by the speech recognition device 5 is “Stapelia variegata linn”, the processor 1 determines that the submitted response “Stapelia variegata linn” matches neither the target answer “cactus” nor anyone of the characteristics in the characteristic set corresponding to the target answer “cactus”, and thus controls the audio output device 4 to produce the voice output that contains the negative expression “No”. Meanwhile, the processor 1 determines that the failed event has occurred again. Therefore, the processor 1 increases the value of the counter by one, so the count of consecutive occurrences of the failed event is three and reaches the predetermined threshold. Determining that the count of consecutive occurrences of the failed event reaches the predetermined threshold, the processor 1 selects another hint “succulent plant” in the hint set corresponding to the target answer “cactus”, and controls the audio output device 4 to produce the voice output based on the another hint “succulent plant” thus selected. Additionally, the processor 1 resets the counter to zero.

Once again, when the user replies with a response “Desert rose?” and the submitted response generated by the speech recognition device 5 is “desert rose”, the processor 1 determines that the submitted response “desert rose” matches neither the target answer “cactus” nor any one of the characteristics in the characteristic set corresponding to the target answer “cactus”, and thereby controls the audio output device 4 to produce the voice output that contains the negative expression “No”. At the same time, the processor 1 determines that the failed event has occurred, and hence increases the value of the counter by one. As a consequence, the count of consecutive occurrences of the failed event is one. Next, when the user replies with a response “String of pearls?” and the submitted response generated by the speech recognition device 5 is “string of pearls”, the processor 1 determines that the submitted response “string of pearls” matches neither the target answer “cactus” nor any one of the characteristics in the characteristic set corresponding to the target answer “cactus”, and thus controls the audio output device 4 to produce the voice output that contains the negative expression “No”. Determining that the failed event has occurred, the processor 1 increases the value of the counter by one, so the count of consecutive occurrences of the failed event is now two. Afterwards, when the user replies with a response “Stapelia gigantea?” and the submitted response generated by the speech recognition device 5 is “Stapelia gigantea”, the processor 1 determines that the submitted response “Stapelia gigantea” matches neither the target answer “cactus” nor any one of the characteristics in the characteristic set corresponding to the target answer “cactus”, and controls the audio output device 4 to produce the voice output that contains the negative expression “No”. Moreover, the processor 1 determines that the failed event has occurred, and increases the value of the counter by one. Hence, the count of consecutive occurrences of the failed event is three and reaches the predetermined threshold. Determining that the count of consecutive occurrences of the failed event reaches the predetermined threshold, the processor 1 selects still another hint “pointy leaf tips” in the hint set corresponding to the target answer “cactus”, and controls the audio output device 4 to produce the voice output based on said still another hint “pointy leaf tips” thus selected. In addition, the processor 1 resets the counter to zero.

When the user replies “Bloom?” and the submitted response generated by the speech recognition device 5 is “bloom”, the processor 1 determines that the submitted response “bloom” semantically matches a characteristic in the characteristic set corresponding to the target answer “cactus”, so the processor 1 controls the audio output device 4 to produce the voice output that contains a positive expression such as “Yes”. When the user further replies “Cactus?” and the submitted response generated by the speech recognition device 5 is “cactus”, the processor 1 determines that the submitted response “cactus” matches the target answer “cactus”, so the processor 1 controls the audio output device 4 to produce the voice output expressing that the user's reply is correct such as “Wonderful” or “Correct”.

It is worth to note that the interactive education system 100 according to the disclosure further takes the emotion of the user into account for producing the voice output to enhance interaction between the user and the interactive education system 100.

Specifically speaking, the image capturing device 7 is configured to capture a real-time image of the user. The image capturing device 7 may be implemented by a camera or an image capturing module of an electronic device (e.g., a smartphone).

The emotion recognition device 6 is electrically connected to the processor 1, the speech recognition device 5 and the image capturing device 7. The emotion recognition device 6 is configured to determine an emotion of the user based on the real-time image and the submitted response. The emotion recognition device 6 may be implemented as a single chip, a computation module of a chip, or a circuit configurable/programmable in a software and/or hardware manner to implement functionalities discussed in this disclosure. The emotion recognition device 6 further has a function of image recognition.

The storage device 2 is further configured to store, for each type of emotion, at least one feedback message corresponding to the type of emotion.

The processor 1 is further configured to control the audio output device 4 to produce the voice output based on one of the at least one feedback message corresponding to a type of the emotion of the user determined by the emotion recognition device 6.

For example, the types of the emotion of the user to recognizable by the emotion recognition device 6 include an emotion of happiness and excitement, an emotion of impatience and anger, an emotion of sadness and frustration, an emotion of confusion, and an emotion of confidence.

The emotion recognition device 6 determines that the emotion of the user is the emotion of happiness and excitement based on facts such as that the submitted response contains laughter of the user, singing of the user, or specific phrases (e.g., “Yes”), that the duration it takes to reply by the user is shortened (i.e., the user's response becomes faster), and/or that the real-time image of the user shows a relevant expression (e.g., a smile) of the user.

The at least one feedback message corresponding to the emotion of happiness and excitement may include an inquiry as to whether to proceed to another puzzle, e.g., “Proceed to advanced puzzle?”. When it is determined by the emotion recognition device 6 that the emotion of the user is happiness and excitement and when it is determined by the processor 1 that the submitted response matches the target answer, the processor 1 is configured to control the audio output device 4 to produce the voice output expressing the inquiry as to whether to proceed to another puzzle. When it is determined based on the submitted response that the voice of the user in reply to the inquiry contains a positive expression (e.g., “Yes”), the processor 1 is further configured to control the audio output device 4 to produce the voice output based on one of the hints selected in the hint set corresponding to another target answer.

The emotion recognition device 6 determines that the emotion of the user is the emotion of impatience and anger based on facts such as that the voice volume increases, that the intonation of the user rises to be above a usual level, that the duration it takes to reply by the user is shortened, and/or that the real-time image of the user shows a relevant expression (e.g., a frown, blinking, or eye movement) of the user.

In one embodiment where the interactive education system 100 is integrated into a portable device (e.g., a smartphone or a tablet computer), the emotion recognition device 6 determines that the emotion of the user is impatience and anger further based on facts such as that the portable device is being vigorously shaken, and/or that the user taps a touchscreen of the portable device at wrong positions.

The at least one feedback message corresponding to the emotion of impatience and anger may include a word of encouragement (e.g., “Hang in there!”), music (e.g., a relaxing tune) and/or a joke. Namely, there are at least three feedback messages for the emotion of impatience and anger. When it is determined by the emotion recognition device 6 that the emotion of the user is impatience and anger, the processor 1 is configured to control the audio output device 4 to produce the voice output expressing one of the word of encouragement, the music and the joke, or select another one of the hints in the hint set corresponding to the target answer and control the audio output device 4 to produce the voice output based on said another one of the hints thus selected.

The emotion recognition device 6 determines that the emotion of the user is the emotion of sadness and frustration based on facts such as that an error rate of the reply made by the user is greater than an error threshold value, and/or that the submitted response contains a cry of the user.

In one embodiment where the interactive education system 100 is integrated into the portable device, the emotion recognition device 6 determines that the emotion of the user is sadness and frustration further based on facts such as that the user taps the touchscreen of the portable device at an unexpected position, or that the user presses a specific key (e.g., the escape key “ESC”) of the portable device, and/or based on the speed of operations made on the touchscreen by the user.

The at least one feedback message corresponding to the emotion of sadness and frustration may include a word of encouragement (e.g., “Cheer up!”) and/or a joke. When it is determined by the emotion recognition device 6 that the emotion of the user is sadness and frustration, the processor 1 is configured to control the audio output device 4 to produce the voice output expressing one of the word of encouragement and the joke, or select another one of the hints in the hint set corresponding to the target answer and control the audio output device 4 to produce the voice output based on said another one of the hints thus selected.

The emotion recognition device 6 determines that the emotion of the user is the emotion of confusion based on facts such as that the submitted response contains specific phrases (e.g., “Hmmm . . . ”), or that the real-time image of the user shows a relevant expression (e.g., a frown) of the user, and/or based on a pending time duration prior to making the reply.

The at least one feedback message corresponding to the emotion of confusion may show care and concern (e.g., “Need help?”). When it is determined by the emotion recognition device 6 that the emotion of the user is confusion, the processor 1 is configured to select another one of the hints in the hint set corresponding to the target answer and control the audio output device 4 to produce the voice output based on said another one of the hints thus selected.

The emotion recognition device 6 determines that the emotion of the user is confidence based on facts such as that the voice the user utters is calm.

In one embodiment where the interactive education system 100 is integrated into the portable device, the emotion recognition device 6 determines that the emotion of the user is the emotion of confidence further based on the level of force applied to the touchscreen of the portable device, and/or an inter-taps time interval which may be a time interval between two consecutive touch inputs made by the user.

The at least one feedback message corresponding to the emotion of confidence may include an inquiry as to whether to proceed to another puzzle, e.g., “Proceed to advanced puzzle?”. When it is determined by the emotion recognition device 6 that the emotion of the user is confidence and when it is determined by the processor 1 that the submitted response matches the target answer, the processor 1 is configured to control the audio output device 4 to produce the voice output expressing the inquiry as to whether to proceed to another puzzle. When it is determined based on the submitted response that the voice of the user in reply to the inquiry contains a positive expression (e.g., “Yes”), the processor 1 is further configured to control the audio output device 4 to produce the voice output based on one of the hints selected in the hint set corresponding to another target answer.

In summary, the interactive education system 100 according to the disclosure utilizes the processor 1 to control the audio output device 4 to produce voice to be heard by the user based on the hint on the target answer stored in the storage device 2, utilizes the speech recognition device 5 to generate the submitted response through performing speech recognition on the input voice data that is generated by the audio input device 3 based on voice received from the user, and utilizes the processor 1 to control the audio output device 4 to produce corresponding voice output based on a result of determination as to whether the submitted response matches the target answer or any one of the characteristics in the characteristic set corresponding to the target answer. Depending on the user's performance in view of correctness or relevance of the submitted response, the processor 1 may control the output device to produce the voice output that contains the positive expression, the negative expression or another hint in the hint set corresponding to the target answer. Consequently, the user may be guided to figure out the target answer, step by step, in a deductive manner. Moreover, the interactive education system 100 according to the disclosure utilizes the image capturing device 7 to capture the real-time image of the user, utilizes the emotion recognition device 6 to determine the emotion of the user based on the real-time image, the submitted response and the user's operation of the electronic device, and utilizes the processor 1 to control the audio output device 4 to produce the voice output based on the feedback message corresponding to the type of the emotion of the user thus determined. Since the emotion of the user is taken into account, interactions between the user and the interactive education system 100 may be further enhanced.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An interactive education system comprising:
a storage device configured to store in advance a plurality of reference answers, a plurality of hint sets each corresponding to a respective one of the reference answers and each including multiple hints on the respective one of the reference answers, and a plurality of characteristic sets each corresponding to a respective one of the reference answers and each including multiple characteristics of the corresponding reference answer;
an audio output device configured to produce voice output to a user;
a processor electrically connected to said storage device and said audio output device, and configured to select one of the reference answers as a target answer, to select one of the hints in one of the hint sets that corresponds to the target answer, and to control said audio output device to produce the voice output based on the one of the hints thus selected;
an audio input device configured to receive voice of the user, who makes a reply to the voice output, to generate input voice data; and
a speech recognition device electrically connected to said audio input device and said processor, and configured to perform speech recognition on the input voice data to generate a submitted response;
wherein said processor is further configured to
determine, based on the submitted response, whether the submitted response matches either the target answer or any one of the characteristics in one of the characteristic sets that corresponds to the target answer,
when it is determined that the submitted response matches the target answer, control said audio output device to produce the voice output expressing that the user's reply is correct,
when it is determined that the submitted response matches one of the characteristics in said one of the characteristic sets that corresponds to the target answer, control said audio output device to produce the voice output that contains a positive expression, and
when it is determined that the submitted response matches neither the target answer nor any one of the characteristics in said one of the characteristic sets that corresponds to the target answer, determine that a failed event has occurred, and control said audio output device to produce the voice output that contains a negative expression;
wherein said processor is further configured to, when a count of consecutive occurrences of the failed event reaches a predetermined threshold, select another one of the hints in said one of the hint sets that corresponds to the target answer, and control said audio output device to produce the voice output based on said another one of the hints thus selected; and
wherein said processor is further configured to, when the counts of consecutive occurrences of the failed events for all the hints in said one of the hint sets that corresponds to the target answer have reached the predetermined threshold, control said audio output device to produce the voice output based on the target answer.

2. The interactive education system as claimed in claim 1, wherein the characteristics in any individual one of the characteristic sets include one of a function, an appearance, a color, a growth factor, a growth environment, and any combination thereof of the respective one of the reference answers.

3. The interactive education system as claimed in claim 1, wherein the predetermined threshold is three.

4. The interactive education system as claimed in claim 1, wherein said processor is further configured to, after controlling said audio output device to produce the voice output expressing that the user's reply is correct when it is determined that the submitted response matches the target answer, select another one of the reference answers as another target answer, select one of the hints in another one of the hint sets that corresponds to said another target answer, and control said audio output device to produce the voice output based on the one of the hints thus selected in said another one of the hint sets that corresponds to said another target answer.

5. The interactive education system as claimed in claim 1, further comprising:
an image capturing device configured to capture a real-time image of the user; and
an emotion recognition device electrically connected to said processor, said speech recognition device and said image capturing device, and configured to determine an emotion of the user based on the real-time image and the submitted response,
wherein said storage device is further configured to store, for each type of emotion, at least one feedback message corresponding to the type of emotion,
wherein said processor is further configured to control said audio output device to produce the voice output based on one of the at least one feedback message corresponding to a type of the emotion of the user determined by said emotion recognition device.

6. The interactive education system as claimed in claim 5, wherein:
the at least one feedback message corresponding to an emotion of happiness and excitement includes an inquiry as to whether to proceed to another puzzle;
said processor is configured to, when it is determined by said emotion recognition device that the emotion of the user is the emotion of happiness and excitement and when it is determined by said processor that the submitted response matches the target answer, control said audio output device to produce the voice output expressing the inquiry as to whether to proceed to another puzzle; and
said processor is further configured to, when it is determined based on the submitted response that the voice of the user in reply to the inquiry contains a positive expression, control said audio output device to produce the voice output based on the one of the hints thus selected in said another one of the hint sets that corresponds to said another target answer.

7. The interactive education system as claimed in claim 5, wherein:
the at least one feedback message corresponding to an emotion of impatience and anger includes a word of encouragement, music and a joke; and
said processor is configured to, when it is determined by said emotion recognition device that the emotion of the user is the emotion of impatience and anger, control said audio output device to produce the voice output expressing one of the word of encouragement, the music and the joke, or select another one of the hints in said one of the hint sets that corresponds to the target answer and control said audio output device to produce the voice output based on said another one of the hints thus selected.

8. The interactive education system as claimed in claim 5, wherein:
the at least one feedback message corresponding to an emotion of sadness and frustration includes a word of encouragement and a joke; and
said processor is configured to, when it is determined by said emotion recognition device that the emotion of the user is the emotion of sadness and frustration, control said audio output device to produce the voice output expressing one of the word of encouragement and the joke, or select another one of the hints in said one of the hint sets that corresponds to the target answer and control said audio output device to produce the voice output based on said another one of the hints thus selected.

9. The interactive education system as claimed in claim 5, wherein said processor is configured to, when it is determined by said emotion recognition device that the emotion of the user is an emotion of confusion, control said audio output device to select another one of the hints in said one of the hint sets that corresponds to the target answer and control said audio output device to produce the voice output based on said another one of the hints thus selected.

10. The interactive education system as claimed in claim 5, wherein:
the at least one feedback message corresponding to an emotion of confidence includes an inquiry as to whether to proceed to another puzzle;
said processor is configured to, when it is determined by said emotion recognition device that the emotion of the user is the emotion of confidence and when it is determined by said processor that the submitted response matches the target answer, control said audio output device to produce the voice output expressing the inquiry as to whether to proceed to another puzzle; and
said processor is further configured to, when it is determined based on the submitted response that the voice of the user in reply to the inquiry contains a positive expression, control said audio output device to produce the voice output based on the one of the hints thus selected in another one of the hint sets that corresponds to said another target answer.
